(19) United States
(12) Patent Application Publication
(10) Pub. No.: US 2026/0311118 A1
(43) Pub. Date: Oct. 8, 2026

(54) INTELLIGENT ORDER RESPONSE

(71) Applicant: Logility, Inc., Atlanta, GA (US)

(72) Inventors: Ranjith Narayanan, Atlanta, GA (US); Indrava Roy, Atlanta, GA (US); Dylan Bollen, Atlanta, GA (US); Somesh Rao, Atlanta, GA (US)

(21) Appl. No.: 19/637,652

(22) Filed: Apr. 2, 2026

Related U.S. Application Data
(60) Provisional application No. 63/782,442, filed on Apr. 2, 2025.

(51) Int. Cl. G06Q 10/087; G06F 40/205

(52) U.S. Cl. CPC G06Q 10/08726; G06F 40/205

(57) ABSTRACT

Systems, methods, and apparatuses disclosed herein may include an intelligent order response (IOR) system and method for optimizing supply chain order fulfillment. The IOR system automates demand-supply matching, applies graph-based problem simplification, and incorporates probabilistic risk-weighted analysis to improve order allocation and fulfillment efficiency. The IOR system receives demand data and supply data, processes constraints and objectives using a domain-specific language (DSL), and generates a structured optimization model. A graph-based transformation simplifies the fulfillment problem by partitioning it into independent subproblems, which are processed using a pluggable solver system. The IOR system dynamically selects solvers based on problem complexity, computational efficiency, and customer-defined priorities. A probabilistic solver adjusts fulfillment plans by accounting for external disruptions, supplier reliability, and demand fluctuations. Optimized fulfillment recommendations are presented to users through an interactive AI-driven interface, enabling real-time adaptability.

### CROSS-REFERENCE TO RELATED APPLICATIONS

This application claims the benefit of, and priority to, U.S. Provisional Application No. 63/782,442, filed on Apr. 2, 2025, and entitled “INTELLIGENT ORDER RESPONSE,” the contents of which are hereby incorporated by reference in its entirety as if set forth herein.

### TECHNICAL FIELD

The present disclosure generally relates to computer-implemented methods and systems for supply chain order fulfillment and optimization, and more specifically to systems, methods, and apparatuses for intelligent order response using automated demand-supply matching, graph-based problem simplification, and probabilistic risk-weighted analysis to optimize order allocation and fulfillment in dynamic supply chain environments.

### BACKGROUND

In modern supply chain operations, order fulfillment involves complex decision-making processes that require balancing multiple factors, such as demand fluctuations, supply constraints, inventory levels, and cost considerations. Organizations must allocate available inventory and resources efficiently while adapting to disruptions, supplier reliability issues, and shifting customer priorities. Traditional approaches to order fulfillment often rely on manual interventions, rule-based heuristics, or simplistic optimization models, which lack the flexibility to respond dynamically to real-time changes in supply chain conditions.

A significant challenge in supply chain order fulfillment is the computational complexity of matching supply to demand while adhering to business constraints and optimization objectives. The number of possible allocations increases exponentially as the number of supply sources and demand points grows, leading to intractable computational burdens when attempting to determine an optimal order fulfillment plan. Additionally, external factors such as weather events, transportation delays, and geopolitical disruptions introduce uncertainty in supply availability, further complicating fulfillment decisions.

Another problem faced by organizations is the difficulty of defining optimization objectives and constraints in a machine-readable format. Supply chain professionals may have a conceptual understanding of their business goals (e.g., maximizing profit margins or ensuring high service levels) but struggle to articulate these objectives in a form that can be processed by traditional computational models. Existing systems often require manual data entry and rigid rule-based configurations, making them cumbersome, error-prone, and difficult to scale.

Furthermore, existing order fulfillment systems typically operate in a reactive manner, making decisions based on static snapshots of demand and supply rather than continuously adapting to changing conditions. This lack of adaptability can result in suboptimal allocations, increased costs, missed delivery commitments, and excessive inventory holding costs. Organizations also face challenges in integrating different solver technologies for complex optimization problems, often being forced to rely on a single solver that may not be well-suited for every type of order fulfillment scenario.

Accordingly, there is an unresolved need for a system and method that optimizes supply chain order fulfillment, handles computational complexity efficiently, incorporates real-time data-driven decision-making, and/or allows users to define constraints and objectives in a flexible, machine-readable format.

This background information is provided to reveal information believed by the applicant to be of possible relevance. No admission is necessarily intended, nor should be construed, that any of the preceding information constitutes prior art.

### SUMMARY

Briefly described, and in various embodiments, the present disclosure generally relates to systems, methods, and apparatuses for intelligent order response in supply chain management, and more specifically to computer-implemented systems and methods for optimizing order fulfillment by leveraging automated demand-supply matching, graph-based problem simplification, and probabilistic risk-weighted analysis.

Traditional supply chain order fulfillment systems face several challenges, including the computational complexity of optimizing supply-demand allocation, the rigid and error-prone nature of rule-based fulfillment models, and the difficulty of defining optimization objectives in a machine-readable format. The increasing scale of global supply chains introduces further complexities, such as unpredictable disruptions, fluctuating demand, and the need for real-time decision-making. Many conventional approaches operate in a reactive manner, making decisions based on static data rather than continuously adapting to evolving supply chain conditions. Additionally, organizations often struggle with integrating multiple solver technologies and selecting appropriate optimization strategies based on computational efficiency and business priorities.

To address these challenges, the present disclosure provides systems and methods in which one or more computing devices receive demand data and supply data associated with one or more orders within a predefined fulfillment window. The demand data and the supply data are parsed using a domain-specific language (DSL) that allows for the structured representation of supply chain constraints and objectives. A structured specification is generated based on the DSL, where the specification includes variables representing supply chain parameters, constraints defining allowable fulfillment conditions, and an objective function optimizing at least one business metric such as profit maximization, service level improvement, or cost minimization.

To reduce computational complexity, the structured specification is transformed into a graph representation comprising connected components that define subproblems within the supply chain. The graph-based problem simplification partitions large-scale optimization problems into independent subproblems, allowing for more efficient computation and parallel processing. A pluggable solver system dynamically selects an appropriate solver based on problem complexity, computational efficiency, or customer priority level. The solver system may include commercial solvers, open-source solvers, or proprietary solvers, such as Gurobi, Branch and Cut solver (CBC), and HIGHs (e.g., a proprietary solver), and may incorporate a fallback mechanism that automatically switches solvers based on computational constraints.

To further enhance decision-making, a probabilistic risk-weighted analysis may be performed, adjusting the optimized order fulfillment plan based on uncertainty factors such as external disruptions, supplier reliability, or probabilistic demand-supply fluctuations. Multiple weighted optimization paths may be generated, each representing different trade-offs between competing business priorities. Optimized recommendations may be provided to users via an AI-driven user interface, which may include a conversational AI assistant. The AI assistant, implemented using a large language model (LLM) trained on historical supply chain data, may allow users to define constraints and objectives using natural language, thereby reducing the complexity of configuring optimization parameters.

Additionally, aspects of the disclosure may enable real-time monitoring and dynamic adaptation, continuously updating order fulfillment recommendations as demand and supply conditions change. An optimized order fulfillment plan may be stored in an output database, allowing for historical analysis, key performance indicator (KPI) tracking, and/or predictive analytics. The predictive analytics may forecast future demand-supply mismatches based on historical trends and real-time data inputs, further enhancing supply chain agility.

By integrating graph-based problem simplification, a pluggable solver system, probabilistic risk-weighted analysis, and an AI-driven user interface, the disclosed systems and methods may improve the efficiency, adaptability, and scalability of supply chain order fulfillment. Moreover, the disclosed intelligent order response system and method may automate and optimize allocation decisions, enabling organizations to reduce costs, improve service levels, mitigate supply chain risks, and dynamically adapt to changing market conditions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an end-to-end system architecture according to various embodiments of the present disclosure;

FIG. 2 illustrates an exemplary environment according to various embodiments of the present disclosure;

FIG. 3 illustrates example data flow according to various embodiments of the present disclosure;

FIG. 4 illustrates an example process according to various embodiments of the present disclosure;

FIG. 5 illustrates a schematic of an exemplary device according to various embodiments of the present disclosure; and

FIG. 6 illustrates an exemplary diagrammatic representation of a machine in the form of a computer system according to various embodiments of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

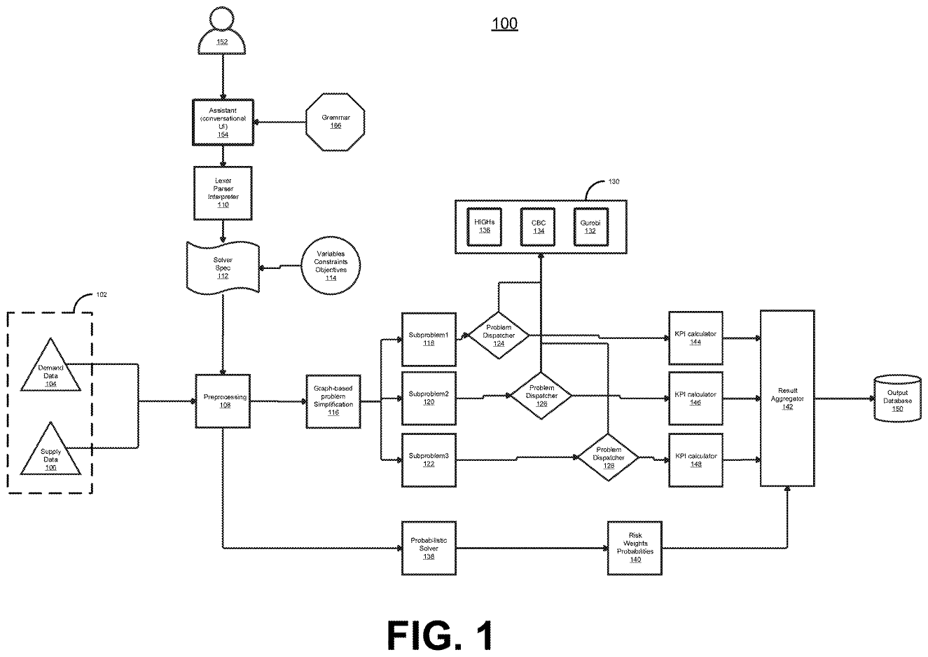

Referring now to the figures, for the purposes of example and explanation of the fundamental processes and components of the disclosed systems and processes, reference is made to FIG. 1, which illustrates an end-to-end system architecture 100 for an intelligent order response (IOR) system associated with supply chain order fulfillment. The system architecture 100 may include multiple interconnected components that interact to receive demand and supply data, process constraints and objectives, apply optimization techniques, and generate an optimized order fulfillment plan. The components may operate together to enable real-time, automated, and adaptive order fulfillment based on dynamically changing conditions and business objectives.

The system architecture 100 may include a data ingestion module 102, which may be responsible for collecting and integrating demand data 104 and supply data 106 from multiple internal and external sources. The internal and external sources may include enterprise resource planning (ERP) systems, which may provide details about order processing and/or procurement. Moreover, the internal and external sources may include warehouse management systems (WMS), which may track inventory availability and movement. Furthermore, the internal and external sources may include third-party logistics (3PL) providers, which may supply transportation schedules, estimated delivery times, and/or routing constraints.

The data ingestion module 102 may incorporate mechanisms for real-time data synchronization, so that up-to-date demand and supply information is available for order fulfillment planning. According to some aspects, the data ingestion module 102 may use application programming interface (API)-based connectors to interface with external data sources, pulling data on a scheduled or event-triggered basis. In some embodiments, the data ingestion module 102 may use message queue systems, such as Apache Kafka or RabbitMQ, to support streaming data ingestion, allowing the system to process incoming demand and supply updates as they arrive. In some embodiments, the data ingestion module 102 may support both real-time streaming ingestion and batch import modes, where batch mode may be used for periodic bulk data loads from systems that do not support real-time data exchange. The data ingestion module 102 may also handle data format normalization, converting data from disparate sources into a standardized internal representation.

Once collected, the demand data 104 and the supply data 106 may be processed by a preprocessing module 108, which may standardize, validate, and structure the demand data 104 and the supply data 106 into a format compatible with the system's optimization models. The preprocessing module 108 may perform various operations, such as unit conversion, missing data imputation, anomaly detection, and/or outlier filtering. For example, if demand data 104 includes multiple units of measurement (e.g., cases, pallets, and/or individual units), the preprocessing module 108 may convert all data into a standard format to prevent inconsistencies in the optimization process.

According to some aspects, the preprocessing module 108 may perform anomaly detection to identify data entries that deviate from expected patterns. In some embodiments, the preprocessing module 108 may apply statistical methods for anomaly detection, such as z-score analysis, interquartile range (IQR)-based filtering, or standard deviation thresholds, to flag data points that fall outside an expected range. In some embodiments, the preprocessing module 108 may use a machine learning model trained on historical supply chain data to detect anomalies that may not be captured by statistical methods alone, such as unusual ordering patterns or sudden changes in supplier behavior.

The preprocessing module 108 may also perform missing data imputation to address incomplete records in the demand data 104 or supply data 106. In some embodiments, missing data may be imputed using historical averages computed from prior records for the same product, supplier, or customer. In some embodiments, nearest-neighbor methods may be used, where missing values are estimated based on the values of similar records. In some embodiments, regression-based imputation methods may be applied, where a regression model predicts missing values based on correlated features in the dataset.

Moreover, the preprocessing module 108 may assign reliability scores to suppliers based on historical fulfillment performance. For example, if supply data 106 indicates that a supplier has previously experienced frequent shipment delays, the preprocessing module 108 may assign a lower reliability score to that supplier, which may affect the supplier's prioritization in the order fulfillment process. In some embodiments, the reliability score may be calculated as a weighted function of historical on-time delivery rate, order accuracy, lead time consistency, and/or quality metrics. In some embodiments, the reliability score may be computed using a weighted moving average that gives greater weight to more recent performance data.

A user 152 may interact with the IOR system via a user interface, which may include a conversational AI assistant 154 comprising a large language model (LLM). According to some aspects, the LLM may be trained on, or fine-tuned using, historical supply chain data, including past order fulfillment records, constraint configurations, and user queries, to enhance its ability to generate accurate structured queries and optimization recommendations. The AI assistant 154 may enable users to define constraints and objectives using natural language and may translate natural language user queries into structured queries that are compatible with a DSL processing module 110. For example, a supply chain manager may input, “Prioritize shipments from Supplier A if delivery times are under three days, otherwise use Supplier B.” The AI assistant 154 may translate the request into an optimization rule, which may then be processed by the DSL processing module 110 and incorporated into a structured specification 112.

According to some aspects, the AI assistant 154 may use prompt engineering, fine-tuning, or retrieval-augmented generation (RAG) to translate natural language inputs into structured queries compatible with the DSL. In a RAG-based implementation, the AI assistant 154 may retrieve relevant constraint templates or previously defined optimization rules from a knowledge base and use them to inform the translation of the user's natural language input. The AI assistant 154 may also include a validation mechanism that checks the translated structured query against the DSL grammar to confirm that the output is syntactically and semantically valid. In some embodiments, upon detecting an invalid or ambiguous translation, the AI assistant 154 may prompt the user 152 for clarification or present multiple candidate interpretations for the user 152 to select among.

In some embodiments, the AI assistant 154 may present the translated structured query to the user 152 for confirmation before the query is incorporated into the optimization process, allowing the user 152 to verify that the translated query accurately reflects the intended constraint or objective. In some embodiments, the AI assistant 154 may suggest constraints or objectives based on historical user preferences, organizational policies, or patterns identified in prior user interactions stored in user interaction logs. In some embodiments, the AI assistant 154 may generate natural language explanations of optimization results, providing justifications for recommended allocations in a format that is accessible to non-technical users.

The system architecture 100 may include a grammar 166, which may define the syntactic rules and production rules used by the DSL processing module 110 and/or the AI assistant 154. The grammar 166 may specify the valid structure of DSL expressions, including how variables, operators, constraints, and objectives may be composed. According to some aspects, the grammar 166 may be implemented as a context-free grammar (CFG) that defines the set of valid DSL expressions using a set of production rules. The grammar 166 may be used by the AI assistant 154 to validate translated queries and by the DSL processing module 110 to parse and interpret structured input.

The DSL processing module 110 may enable users to define business rules, constraints, and objectives in a structured, machine-readable format. According to some aspects, the DSL processing module 110 may include a lexer, a parser, and/or an interpreter, which may work together to convert natural language constraints and objectives into the structured specification 112 that may be used for optimization. The lexer may tokenize the input into smaller components, such as identifiers, operators, numeric literals, and reserved words. The parser may organize the tokenized components into a hierarchical structure, such as an abstract syntax tree (AST), according to the production rules defined by the grammar 166. The interpreter may traverse the AST and evaluate the structured input to generate executable optimization rules.

The DSL may support various types of expressions for representing supply chain constraints and objectives. For example, the DSL may support variable declaration expressions that define supply chain parameters. An example variable declaration expression may take the form “DEFINE shipping_cost AS FLOAT” or “DEFINE lead_time AS INTEGER” or “DEFINE allocated_quantity AS INTEGER,” where each expression declares a named variable with an associated data type. The DSL may also support constraint expressions that specify allowable fulfillment conditions. An example constraint expression may take the form “CONSTRAINT lead_time<=3 FOR supplier =Supplier_A” or “CONSTRAINT allocated_quantity<=supplier_capacity,” where each expression defines a logical condition that a feasible fulfillment plan is to satisfy. Furthermore, the DSL may support objective expressions that specify the optimization goal. An example objective expression may take the form “MINIMIZE SUM(shipping_cost*allocated_quantity)” or “MAXIMIZE SUM(service_level_score*order_priority),” where each expression defines a function to be optimized across the set of allocation decisions.

In some embodiments, the DSL may support conditional expressions that allow users to define branching logic. For example, a conditional expression may take the form “IF supplier. lead_time<48 THEN supplier.priority=HIGH ELSE supplier.priority=LOW,” where the expression assigns a priority classification based on a supplier's lead time. In some embodiments, the DSL may support temporal constraint expressions that express delivery windows, lead time bounds, or time-based fulfillment conditions. For example, a temporal constraint expression may take the form “CONSTRAINT delivery_date BETWEEN order_date AND order_date+5.” In some embodiments, the DSL may support multi-objective expressions where a user specifies weights across competing objectives directly in the DSL syntax. For example, a multi-objective expression may take the form “MINIMIZE 0.6*total_cost+0.4*(1−service_level),” where the expression defines a weighted combination of cost minimization and service level maximization. In some embodiments, the DSL may be extensible, allowing users to define custom functions or operators that encapsulate domain-specific logic for use in constraint and objective expressions.

The structured specification 112 may define parameters 114, including variables (e.g., supply availability, transportation cost per unit, allocated quantity), constraints (e.g., delivery time restrictions, supplier lead times, capacity limits), and/or objectives (e.g., maximizing on-time fulfillment, minimizing fulfillment cost). According to some aspects, the structured specification 112 may represent the order fulfillment problem as a mathematical programming formulation. The variables in the structured specification 112 may correspond to decision variables in the formulation, such as the quantity of supply allocated from each supply source to each demand point. The constraints may correspond to linear or nonlinear inequality and equality constraints that define the feasible region of the optimization problem. The objective function may be expressed as a linear or nonlinear function of the decision variables that the solver is to optimize (e.g., minimize or maximize). In some embodiments, the structured specification 112 may be represented in a standardized format such as LP format, MPS format, or a JSON-based representation that encodes the variables, constraints, and objective function in a structured data object. In some embodiments, the structured specification 112 may be stored as an in-memory data structure that is passed directly to a solver interface.

Once the structured specification 112 is generated, it may be merged with structured demand and supply data in the preprocessing module 108, so that all relevant information is formatted and available for optimization. A graph-based problem simplification module 116 may then process the structured data by decomposing the supply chain order fulfillment problem into multiple independent subproblems.

The graph-based problem simplification module 116 may construct a graph-based representation of the fulfillment problem, wherein nodes represent supply sources and demand points, and edges represent feasible fulfillment paths between supply sources and demand points. According to some aspects, each supply node may be associated with attributes such as available inventory quantity, unit cost, lead time, geographic location, and/or reliability score. Each demand node may be associated with attributes such as order quantity, requested delivery date, product specification, and/or customer priority level. Each edge may represent a feasible allocation of supply from a supply node to a demand node and may be associated with attributes such as transportation cost, estimated delivery time, and/or maximum transferable quantity.

In some embodiments, the graph may be constructed as a bipartite graph, with supply nodes on one side and demand nodes on the other, where edges connect supply nodes to demand nodes that they are capable of serving. In some embodiments, the graph may include intermediate nodes representing distribution centers, cross-docking facilities, or transportation hubs, allowing the system to model multi-echelon fulfillment pathways. In some embodiments, edges in the graph may be weighted, where the weight represents a cost, distance, lead time, or other metric relevant to the fulfillment decision.

Once the graph is constructed, the graph-based problem simplification module 116 may identify connected components within the graph. A connected component may be a maximal subset of nodes and edges such that a path exists between every pair of nodes in the subset, and no edges connect nodes in the subset to nodes outside the subset. The identification of connected components may be performed using a graph traversal algorithm. In some embodiments, a depth-first search (DFS) algorithm may be used, where the algorithm starts at an unvisited node, explores as far as possible along each branch before backtracking, and marks all visited nodes as belonging to the same connected component. In some embodiments, a breadth-first search (BFS) algorithm may be used. In some embodiments, a union-find (disjoint set) data structure may be used, where each node is initially assigned to its own set, and sets are merged whenever an edge is found connecting two nodes in different sets. The resulting disjoint sets correspond to the connected components of the graph.

Each connected component may represent an independent subproblem that can be solved separately from other connected components without affecting the optimality of the overall solution. In some embodiments, where the graph does not decompose into fully disjoint connected components (e.g., where subproblems share a supplier or transportation resource), the graph-based problem simplification module 116 may apply graph clustering techniques to partition the graph into loosely coupled subproblems. In some embodiments, spectral clustering may be applied, where the graph's Laplacian matrix is computed and its eigenvectors are used to partition the nodes into clusters. In some embodiments, community detection algorithms may be applied to identify groups of nodes that are densely connected internally but sparsely connected to other groups. In some embodiments, the system may apply a threshold to edge weights and prune edges with weights below the threshold before identifying connected components, effectively converting a loosely connected graph into a set of disjoint subgraphs.

The decomposition of the fulfillment problem into independent subproblems may reduce the computational complexity of the optimization process. Without decomposition, the problem of allocating m supply lots to n orders may involve evaluating allocation combinations that grow exponentially, where the number of possible binary allocation decisions results in a computational complexity on the order of O(2^(m*n)). By identifying connected components and solving each subproblem independently, the graph-based problem simplification module 116 may reduce the effective computational complexity. In embodiments where the supply-demand graph decomposes into multiple connected components, each containing a fraction of the total supply lots and orders, the aggregate computation across all subproblems may be reduced to a complexity on the order of O(m log n), where m represents the number of supply lots and n represents the number of orders. The graph traversal operations used to identify connected components (e.g., DFS, BFS, or union-find) may themselves operate in O(V+E) time, where V is the number of nodes and E is the number of edges in the graph.

The graph-based problem simplification module 116 may assign each connected component to a respective subproblem. For example, subproblem 1 118 may correspond to urgent orders requiring express delivery, so that time-sensitive fulfillment constraints may be addressed separately. As another example, subproblem 2 120 may address bulk shipments to regional distribution centers, grouping large orders together. Subproblem 3 122 may manage supplier-based allocations, where orders are fulfilled from suppliers selected based on reliability scores and cost-effectiveness. After decomposition, each subproblem may be represented as a separate structured specification or separate graph object that is passed independently to downstream components of the system.

Each subproblem may be assigned to a problem dispatcher 124, 126, 128, which may evaluate characteristics of the subproblem to determine an appropriate solver for optimization. According to some aspects, each problem dispatcher may evaluate one or more of the following characteristics: the number of decision variables in the subproblem, the number of constraints, the type of optimization problem (e.g., linear programming, integer programming, mixed-integer programming, or nonlinear programming), the presence of binary or integer variables, the estimated solve time based on historical data for similar problem sizes, and/or the customer priority level associated with the orders in the subproblem.

In some embodiments, the problem dispatcher may use a rule-based classification to map problem characteristics to a solver selection. For example, if a subproblem contains fewer than a predefined number of decision variables and is a linear programming problem, the problem dispatcher may select a lightweight solver. If the subproblem is a mixed-integer programming problem with a large number of constraints, the problem dispatcher may select a commercial solver. In some embodiments, the problem dispatcher may use a machine learning model trained on historical records of problem characteristics and solver performance to predict which solver is suitable for a given subproblem. The machine learning model may be trained on features such as problem size, constraint density, variable types, and historical solve time, and may output a solver recommendation along with an estimated solve time.

The system architecture 100 may include a pluggable solver system 130, which may dynamically select from multiple solver engines depending on problem characteristics. The pluggable solver system 130 may support multiple categories of solvers, including commercial solvers, open-source solvers, and/or custom-built solvers designed for domain-specific supply chain constraints. According to some aspects, the pluggable solver system 130 may include a first solver 132 (e.g., Gurobi), a second solver 134 (e.g., CBC (Coin-or Branch and Cut)), and/or a third solver 136 (e.g., HiGHS). Different solvers may have different characteristics with respect to problem types, solve speed, solution precision, and/or licensing cost, and the pluggable solver system 130 may select among them based on the characteristics of each subproblem.

According to some aspects, the pluggable solver system 130 may use a standardized solver interface that provides a common API through which the problem dispatchers 124, 126, 128 communicate with the individual solver engines. The standardized solver interface may accept a structured specification (or a portion thereof corresponding to a subproblem) as input and return a solution object that includes the optimized decision variable values and associated objective function value. The standardized interface may allow new solvers to be integrated into the pluggable solver system 130 without modifying the upstream components of the system architecture 100. In some embodiments, the individual solver engines may be deployed as containerized microservices, allowing independent scaling and resource allocation for different solver types. In some embodiments, the pluggable solver system 130 may execute multiple solvers on the same subproblem in parallel and select the result that achieves the best objective function value or satisfies a predefined quality criterion.

The pluggable solver system 130 may include a fallback mechanism that automatically switches between solvers in response to computational constraints. According to some aspects, the fallback mechanism may be triggered when a first solver exceeds a predefined time limit without returning a solution or returns an infeasible result. In some embodiments, the fallback mechanism may be triggered when a solver returns a solution that does not satisfy a minimum quality threshold, such as a minimum gap between the solution's objective value and a known bound. In some embodiments, the fallback mechanism may maintain a ranked list of alternative solvers, ordered by expected performance for the given problem type, and may sequentially attempt each alternative solver until a satisfactory solution is obtained. In some embodiments, partial results from a first solver (e.g., a feasible but suboptimal solution) may be retained and provided as a warm start to the fallback solver to reduce solve time.

Each problem dispatcher 124, 126, 128 may assign a subproblem to a solver selected from the pluggable solver system 130 based on the subproblem's characteristics. Once the solvers execute their respective subproblems, the respective results may be analyzed by a KPI calculator 144, 146, 148 to assess performance metrics associated with the solution. According to some aspects, the KPI calculators 144, 146, 148 may compute one or more of the following metrics: fulfillment accuracy (e.g., the percentage of demand points for which the allocated supply meets or exceeds the requested quantity), cost efficiency (e.g., total transportation and storage cost relative to a baseline or budget), on-time delivery rate (e.g., the percentage of allocations estimated to arrive within the requested delivery window), supplier utilization rate (e.g., the fraction of each supplier's capacity used in the fulfillment plan), and/or order fill rate (e.g., the fraction of total demand that is satisfied by the fulfillment plan).

In some embodiments, the KPI calculators 144, 146, 148 may compute the performance metrics using formulas that take as input the solver's optimized allocation decisions and the associated demand, supply, and cost data. For example, the on-time delivery rate may be computed as the number of allocations with an estimated delivery time less than or equal to the requested delivery date, divided by the total number of allocations. In some embodiments, KPI values may be compared against predefined thresholds, and if one or more KPI values fall below a threshold, the system may trigger re-optimization of the corresponding subproblem with modified constraints or a different solver.

In addition to the deterministic solvers in the pluggable solver system 130, the system architecture 100 may include a probabilistic solver module 138, which may incorporate uncertainty factors into the optimization process. The uncertainty factors may include supplier reliability, weather disruptions, transportation delays, demand variability, and/or market volatility. The probabilistic solver module 138 may generate risk-weighted optimization paths 140, which may present different fulfillment scenarios that balance different trade-offs, such as cost versus reliability, or delivery speed versus fulfillment completeness.

According to some aspects, the probabilistic solver module 138 may model uncertainty using probability distributions associated with uncertain parameters. For example, a supplier's lead time may be modeled as a random variable following a probability distribution (e.g., a normal distribution, a log-normal distribution, or an empirical distribution) derived from historical lead time data for that supplier. Similarly, demand quantities may be modeled as random variables with distributions estimated from historical demand patterns and external signals. In some embodiments, the probabilistic solver module 138 may use Monte Carlo simulation to generate a plurality of scenarios, where each scenario represents a possible realization of the uncertain parameters. The solver may then optimize the fulfillment plan across the plurality of scenarios, for example by minimizing the expected cost or maximizing the expected service level across all scenarios.

In some embodiments, the probabilistic solver module 138 may use stochastic programming with recourse, where a first-stage decision is made before uncertainty is resolved, and a second-stage recourse decision is made after uncertainty is realized. In some embodiments, the probabilistic solver module 138 may use robust optimization, where the fulfillment plan is optimized against a worst-case realization of the uncertain parameters within a predefined uncertainty set. In some embodiments, the probabilistic solver module 138 may use Bayesian updating to dynamically adjust probability distributions as new data becomes available, such as updated supplier performance data or real-time weather forecasts.

According to some aspects, the probabilistic solver module 138 may assign risk weights to different supply chain scenarios based on the estimated probability and impact of each scenario. For example, if historical data indicates that a particular supplier has a 20% probability of shipment delays due to weather conditions in a given region, the probabilistic solver module 138 may assign a corresponding risk weight to fulfillment paths involving that supplier. The risk-weighted optimization paths 140 may include multiple fulfillment plans, each associated with a different risk profile, allowing decision-makers to select a plan that aligns with their risk tolerance. Each of the risk-weighted optimization paths 140 may represent a different trade-off between business priorities, such as cost versus reliability or speed versus fulfillment completeness.

In some embodiments, the probabilistic solver module 138 may compute a confidence level associated with each optimized order fulfillment plan. The confidence level may represent the probability that the fulfillment plan will achieve its target performance metrics (e.g., on-time delivery rate, cost budget) given the estimated uncertainty in the supply chain parameters. The confidence level may be computed based on the distribution of outcomes across the simulated scenarios. For example, if 85% of simulated scenarios result in the fulfillment plan meeting its target service level, the confidence level for that plan may be 85%.

The outputs from the pluggable solver system 130 and the probabilistic solver module 138 may be aggregated by a result aggregator 142. The result aggregator 142 may compile optimized allocations from multiple subproblems into a combined fulfillment plan. According to some aspects, the result aggregator 142 may merge the solutions from individual subproblems by combining the allocation decisions from each subproblem's solution into a single allocation table that maps each supply source to each demand point with a corresponding allocated quantity. The result aggregator 142 may also incorporate the risk-weighted optimization paths 140 from the probabilistic solver module 138, associating each allocation in the combined plan with a risk assessment.

In some embodiments, the result aggregator 142 may perform a post-aggregation feasibility check to verify that the combined fulfillment plan satisfies global constraints that span multiple subproblems, such as total budget constraints, total transportation capacity constraints, or cross-regional regulatory requirements. If the feasibility check identifies a constraint violation, the result aggregator 142 may trigger re-optimization of one or more subproblems with modified constraints. In some embodiments, the result aggregator 142 may produce a single recommended fulfillment plan. In some embodiments, the result aggregator 142 may produce a plurality of ranked fulfillment plan alternatives, each representing a different trade-off profile between competing objectives such as cost, service level, and risk.

The aggregated results may be stored in an output database 150, allowing for historical analysis, predictive analytics, and/or performance tracking. In some embodiments, the output database 150 may be a relational database. In some embodiments, the output database 150 may be a time-series database that stores fulfillment plans and their associated outcomes indexed by time, enabling trend analysis across fulfillment cycles. In some embodiments, the output database 150 may support versioning of fulfillment plans, allowing the system to maintain a history of plan revisions and associated decision rationale.

According to some aspects, the system architecture 100 may support the definition of multi-objective optimization problems, where the objective function in the structured specification 112 may represent a combination of competing business goals. For example, the objective function may be defined as a weighted sum of cost minimization and service level maximization, where user-defined weights determine the relative priority of each goal. In some embodiments, multi-objective optimization may be implemented using a weighted-sum approach, where the objective function is a linear combination of individual objectives with user-specified weights. In some embodiments, multi-objective optimization may be implemented using an epsilon-constraint method, where one objective is optimized while the remaining objectives are constrained to meet predefined bounds. In some embodiments, multi-objective optimization may be implemented using goal programming, where the solver minimizes deviations from user-specified target values for each objective. In some embodiments, the system may generate a Pareto frontier comprising a set of non-dominated solutions, where no solution can improve one objective without worsening another, and present the Pareto frontier to the user for evaluation.

Additionally, the system architecture 100 may include a demand-supply imbalance detection mechanism. According to some aspects, the system may compare aggregated demand against available supply at predefined intervals or upon ingestion of new demand or supply data. If the comparison identifies a shortage (where demand exceeds available supply) or an overstock condition (where available supply exceeds demand by more than a predefined threshold), the system may trigger an automated alert. In some embodiments, alerts may be transmitted to stakeholders via email, short message service (SMS), push notification, or an in-application notification. In some embodiments, the system may classify imbalances by severity (e.g., based on the magnitude of the gap between demand and supply) and route alerts to different stakeholder groups based on severity level.

The system architecture 100 may further integrate a predictive analytics module that uses output from the solvers and historical data stored in the output database 150 to forecast future demand-supply mismatches. In some embodiments, the predictive analytics module may use time-series models, such as autoregressive integrated moving average (ARIMA) models or exponential smoothing models, to forecast future demand based on historical ordering patterns. In some embodiments, the predictive analytics module may use machine learning models trained on historical fulfillment data, including features such as seasonality, economic indicators, and promotional calendars, to generate demand forecasts. In some embodiments, the predictive analytics module may incorporate external signals, such as weather forecasts, economic indicators, or market trend data, to refine its forecasts. Forecasted demand-supply mismatches may be used by the system to proactively adjust fulfillment strategies, such as pre-positioning inventory or adjusting safety stock levels for products with predicted demand surges.

According to some aspects, the IOR system may continuously update order fulfillment recommendations based on new demand and supply conditions, so that adjustments can be made dynamically in response to supply chain disruptions.

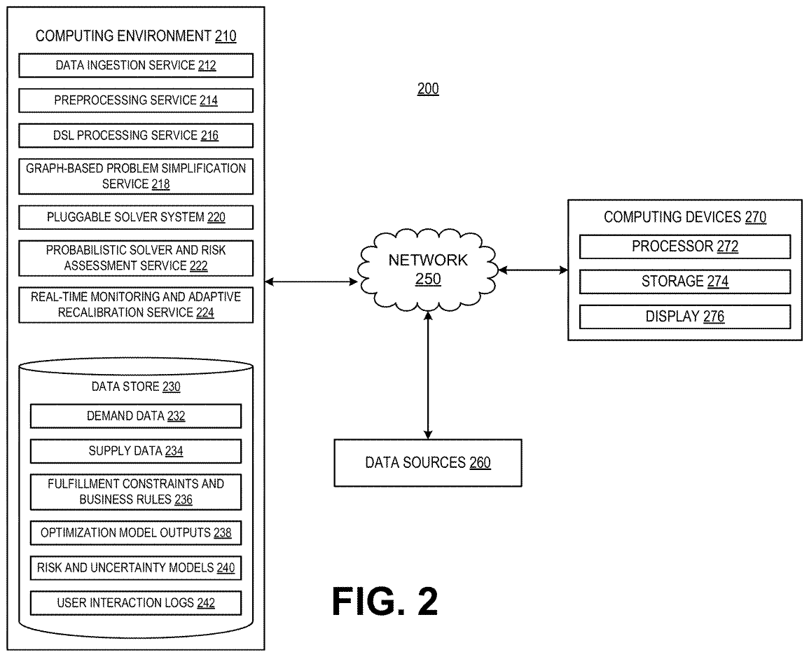

Referring now to FIG. 2, an exemplary networked environment 200 for an IOR system is illustrated according to various embodiments of the present disclosure. The networked environment 200 may facilitate the optimization of supply chain order fulfillment by leveraging automated demand-supply matching, graph-based problem simplification, and probabilistic risk-weighted analysis. The networked environment 200 may include a computing environment 210, which comprises multiple modular services configured to execute various operations related to processing demand and supply data, optimizing order fulfillment strategies, and/or generating fulfillment recommendations based on dynamic conditions.

The computing environment 210 may communicate with one or more data sources 260 and one or more computing devices 270 via a network 250, enabling real-time data exchange, continuous monitoring, and system-wide coordination. The network 250 may encompass various types of communication protocols and configurations, including local area networks (LANs), wide area networks (WANs), cloud-based networks, and hybrid configurations combining on-premises and cloud infrastructure. Additionally, the network 250 may utilize secure communication mechanisms such as Transport Layer Security (TLS), virtual private networks (VPNs), and cloud-based security gateways to maintain data integrity, confidentiality, and protection against unauthorized access.

The computing environment 210 may include multiple modular services, each responsible for specific functions related to data ingestion, preprocessing, optimization, decision analysis, and/or system monitoring. While these services are described separately, it may be appreciated that their functionalities may be distributed across multiple services or consolidated into fewer services within the computing environment 210.

The data ingestion service 212 may collect, integrate, and/or normalize demand and supply data from various sources, including ERP systems, WMS, supplier databases, and/or 3PL providers. The data ingestion service 212 may continuously pull real-time data updates, process batch imports, and/or perform standardization across different formats, as described with respect to the data ingestion module 102 of FIG. 1.

The preprocessing service 214 may clean, validate, and/or structure data before the data is used in downstream optimization processes. The preprocessing service 214 may handle missing values, detect anomalies, standardize units of measurement, and/or enrich data with historical insights, as described with respect to the preprocessing module 108 of FIG. 1.

The DSL processing service 216 may enable users to define business constraints, fulfillment objectives, and/or decision rules in a structured, machine-readable format, as described with respect to the DSL processing module 110 of FIG. 1. The DSL processing service 216 may allow non-technical users to input natural language constraints (e.g., “Prioritize Supplier A if the delivery lead time is under 48 hours”) and translate the natural language constraints into structured optimization rules for integration into the system.

The graph-based problem simplification service 218 may partition complex, large-scale order fulfillment problems into smaller, computationally efficient subproblems, as described with respect to the graph-based problem simplification module 116 of FIG. 1. Partitioning may be achieved by representing supply-demand relationships as a graph, where nodes may represent supply sources and demand locations, and edges may represent fulfillment pathways.

The pluggable solver system 220 may dynamically select an appropriate optimization solver based on problem complexity, computational efficiency, and/or business priorities, as described with respect to the pluggable solver system 130 of FIG. 1. The pluggable solver system 220 may include commercial solvers (e.g., Gurobi), open-source solvers (e.g., CBC), and/or additional solvers (e.g., HiGHS) suitable for different problem types and scales.

The probabilistic solver and risk assessment service 222 may introduce uncertainty modeling into the optimization process, incorporating factors such as supplier reliability, transportation delays, and/or market volatility, as described with respect to the probabilistic solver module 138 of FIG. 1. The probabilistic solver and risk assessment service 222 may generate multiple risk-weighted optimization paths, allowing supply chain managers to evaluate trade-offs between cost, risk, and reliability.

The real-time monitoring and adaptive recalibration service 224 may continuously track changes in demand-supply conditions, external disruptions, and/or inventory fluctuations. If a supply chain disruption occurs (e.g., a factory shutdown, supplier outage, or logistics bottleneck), the real-time monitoring and adaptive recalibration service 224 may dynamically recalculate the fulfillment plan and provide updated recommendations.

According to some aspects, the real-time monitoring and adaptive recalibration service 224 may operate in an event-driven manner, where recalibration is triggered by the detection of a change event such as a new order, a supplier status update, an inventory level change, or an external disruption alert. In some embodiments, the real-time monitoring and adaptive recalibration service 224 may operate in a polling mode, periodically querying data sources for updated information at predefined intervals. In some embodiments, recalibration may be triggered when a detected change exceeds a predefined threshold, such as a demand deviation greater than a predefined percentage of the forecasted demand or a supply reduction that exceeds a predefined quantity.

In some embodiments, the real-time monitoring and adaptive recalibration service 224 may perform incremental re-optimization, where the service updates the fulfillment plan by re-solving the affected subproblem or subproblems rather than re-solving the entire optimization problem. For example, if a supply disruption affects a single supplier, the service may re-optimize the subgraph (connected component) containing that supplier, while leaving the solutions for other subgraphs unchanged. In some embodiments, the service may perform a full re-optimization if the disruption affects multiple connected components or if the incremental approach does not produce a feasible solution.

The computing environment 210 may include a data store 230, which may maintain various datasets for system operations, e.g., demand data 232, supply data 234, fulfillment constraints and business rules 236, optimization model outputs 238, risk and uncertainty models 240, and/or user interaction logs 242.

The demand data 232 may include historical or real-time order demand information, customer purchase trends, and/or demand forecasts. Moreover, the demand data 232 may provide information regarding fluctuations in product demand, seasonal buying patterns, and/or geographic demand variations, enabling the system to anticipate surges and dips in demand. According to some aspects, predictive analytics algorithms may be applied to forecast demand based on historical trends and external factors such as economic conditions or seasonal patterns.

The supply data 234 may include inventory levels, supplier production capacity, warehouse stock allocations, and/or lead time estimations. Moreover, the supply data 234 may allow the system to match demand with available supply across distribution centers, supplier locations, and/or retail outlets. Supply data 234 may include real-time shipment tracking, historical fulfillment performance of suppliers, and/or supplier constraints (e.g., minimum order quantities, production schedules, and compliance requirements). By continuously updating inventory availability and supplier constraints, the system may address stockouts, overstocking, and/or inefficient order allocations.

The fulfillment constraints and business rules 236 may define organizational policies, shipping regulations, priority fulfillment logic, cost thresholds, and/or contractual agreements. These fulfillment constraints and business rules 236 may govern supply chain decisions in accordance with internal business objectives, regulatory requirements, and/or customer agreements. For example, a business rule may specify that orders exceeding a certain volume qualify for bulk discounting, while another business rule may specify that priority customers receive expedited shipping. This dataset may allow the system to incorporate configurable, business-specific fulfillment logic into the optimization framework.

The optimization model outputs 238 may include recommended fulfillment plans, solver-generated solutions, and/or cost-benefit analyses. These outputs may allow supply chain managers to compare multiple fulfillment strategies, evaluate trade-offs between cost and service level, and/or review historical performance metrics. The system may store multiple optimization scenarios, enabling users to simulate alternative strategies based on different constraints or risk conditions.

The risk and uncertainty models 240 may include supplier reliability scores, transportation risk assessments, geopolitical risk indicators, and/or predictive analytics for market volatility. Moreover, the risk and uncertainty models 240 may provide a probabilistic view of potential disruptions. For example, if historical data indicates that a particular supplier has frequent delays due to weather conditions, the system may adjust allocation weightings to favor more reliable suppliers. Additionally, the risk and uncertainty models 240 may integrate real-time risk alerts from external monitoring systems, such as natural disaster warnings or trade policy changes.

The user interaction logs 242 may include records of user-generated queries, manual overrides, and/or system-generated recommendations. By analyzing past user interactions, the system may identify patterns in user preferences, detect inconsistencies in decision-making, and refine AI-driven recommendations. Moreover, the user interaction logs 242 may be used for audit tracking, so that system adjustments and overrides are logged for compliance and performance evaluation.

The computing environment 210 may communicate with one or more data sources 260 and one or more computing devices 270 via the network 250, which may provide secure, high-speed connectivity for data exchange. The computing devices 270 may provide users with access to the IOR system, enabling monitoring, analysis, and/or manual intervention. Each computing device 270 may include a processor 272, storage 274, and/or a display 276, supporting interactive dashboards, supply chain analytics, and/or order fulfillment recommendations.

According to some aspects, the user interface presented on the computing devices 270 may include interactive dashboards displaying fulfillment status, allocation maps, and performance metrics. In some embodiments, the user interface may include a geographic map-based visualization showing supplier locations, demand locations, and fulfillment pathways. In some embodiments, the user interface may include scenario comparison tools that allow users to view side-by-side comparisons of alternative fulfillment plans, including their associated costs, risk profiles, and projected KPI outcomes. In some embodiments, the user interface may allow users to manually override automated recommendations, and the system may log such overrides in the user interaction logs 242 for audit and analysis purposes.

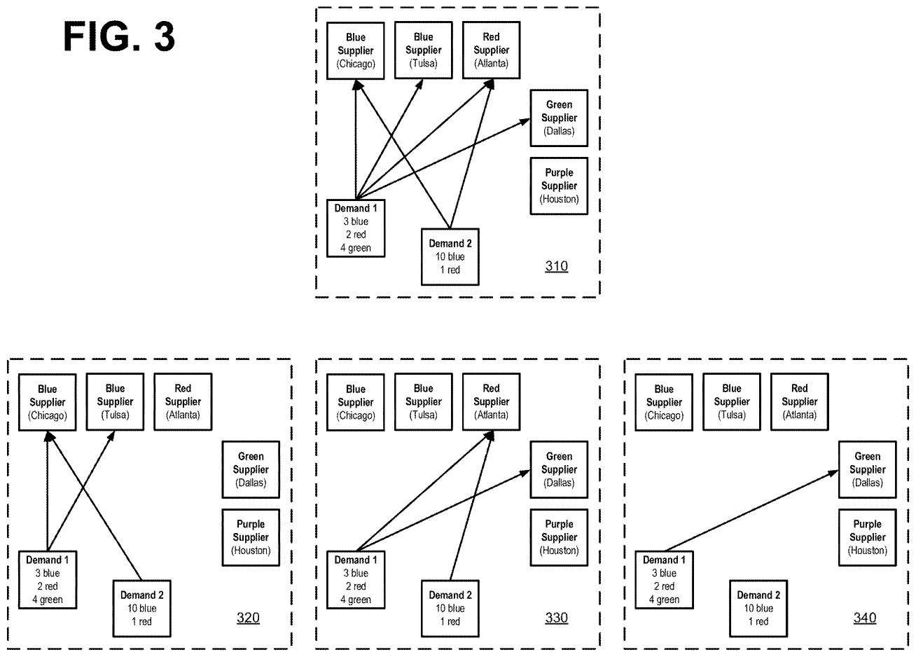

Referring now to FIG. 3, illustrated is an example data structure and flow of information within a supply chain execution system according to various embodiments of the present disclosure. FIG. 3 depicts a network graph 310, which represents demand points, supply sources, and fulfillment pathways in an IOR system. The network graph 310 models supply chain order fulfillment as an interconnected system of supply sources (e.g., suppliers), demand points (e.g., orders), and the relationships between them (e.g., transportation or allocation links). In this representation, each demand point may be associated with a set of specific product requirements, which may be fulfilled by one or more suppliers capable of providing the required inventory.

As illustrated in the network graph 310, two demand points, “Demand 1” and “Demand 2,” may represent distinct order fulfillment requirements. For example, “Demand 1” may require three blue units, two red units, and four green units, while “Demand 2” may require ten blue units and one red unit. These demands may be linked to various suppliers based on their respective inventory and capabilities. Specifically, “Demand 1” is connected to a Blue Supplier in Chicago, a Blue Supplier in Tulsa, a Red Supplier in Atlanta, and a Green Supplier in Dallas, indicating that these suppliers are capable of meeting portions of the required demand. Similarly, “Demand 2” is connected to the Blue Supplier in Chicago and the Red Supplier in Atlanta, representing available sources for fulfilling that specific order.

The network graph 310 also includes a Purple Supplier in Houston, which is depicted in FIG. 3 but is not connected to either “Demand 1” or “Demand 2” by any edge. The Purple Supplier in Houston may represent a supplier that is present in the supply chain network but does not supply products corresponding to the current demand requirements (e.g., purple units are not requested by any current orders). The inclusion of the Purple Supplier in the network graph 310 illustrates that the graph-based decomposition process may naturally identify and isolate disconnected nodes-that is, supply sources that do not have feasible fulfillment paths to any active demand points within the current fulfillment window. Such disconnected nodes may be excluded from the optimization process, further reducing the size of the optimization problem.

The network graph 310 may be computationally complex due to the large number of supply-demand relationships and constraints involved in real-world supply chain operations. Therefore, to enhance computational efficiency, the network graph 310 may be decomposed into subgraphs, each representing a distinct subset of the supply chain problem. These subgraphs may be determined based on connected component identification, as described with respect to the graph-based problem simplification module 116 of FIG. 1. By segmenting the network into smaller subgraphs, the system may reduce the complexity of the optimization problem, enabling parallelized processing.

As shown in FIG. 3, the network graph 310 may be decomposed into three subgraphs: subgraph 320, subgraph 330, and subgraph 340. Subgraph 320 may focus on blue product fulfillment, illustrating connections between “Demand 1” and both the Blue Supplier in Chicago and the Blue Supplier in Tulsa, as well as between “Demand 2” and the Blue Supplier in Chicago. Subgraph 320 thereby isolates the blue product allocation problem, allowing for targeted optimization. For example, if the Blue Supplier in Tulsa offers a lower shipping cost than the Blue Supplier in Chicago, the system may reallocate inventory to reduce total fulfillment expenses while accounting for delivery time constraints.

Subgraph 330 may represent red and green product fulfillment, showing connections between “Demand 1” and the Red Supplier in Atlanta, “Demand 1” and the Green Supplier in Dallas, and “Demand 2” and the Red Supplier in Atlanta. This segmentation may enable optimization of red and green supply chain pathways as a group. For example, if the Red Supplier in Atlanta has a history of inconsistent delivery performance, the system may factor in a risk-adjusted supplier reliability score when optimizing the red product allocation strategy.

Subgraph 340 may further isolate the green product fulfillment by representing the connection between “Demand 1” and the Green Supplier in Dallas. In this scenario, the system may determine whether the Green Supplier in Dallas has sufficient inventory and capacity to meet the full demand for four green units, or whether alternative fulfillment approaches may be applied.

The Purple Supplier in Houston, which appears in the network graph 310 and each of the subgraphs 320, 330, and 340, is not connected to any demand point by any edge. As noted above, the graph-based decomposition process may identify the Purple Supplier in Houston as a disconnected node and may exclude it from all subproblems, thereby reducing the size of the optimization problem. This illustrates how the graph-based approach may filter out supply sources that are not relevant to the current set of demand requirements.

By decomposing the network graph 310 into multiple subgraphs, the system may process smaller subproblems independently and in parallel, reducing the computational burden relative to solving the full network graph as a single optimization problem. This approach also enables the dynamic selection of solvers and optimization techniques for different subgraphs, where different pluggable solvers may be applied to different subgraphs based on their characteristics. For example, a linear programming solver may be applied to a subgraph involving cost minimization with linear constraints, while a mixed-integer programming solver may be applied to a subgraph involving binary allocation decisions.

Additionally, the segmentation into subgraphs may allow the system to adjust fulfillment strategies in response to real-time disruptions. If a supplier becomes unavailable due to a manufacturing issue or shipping delay, the system may dynamically reconfigure the affected subgraph and generate an alternative fulfillment plan without re-optimizing unaffected subgraphs.

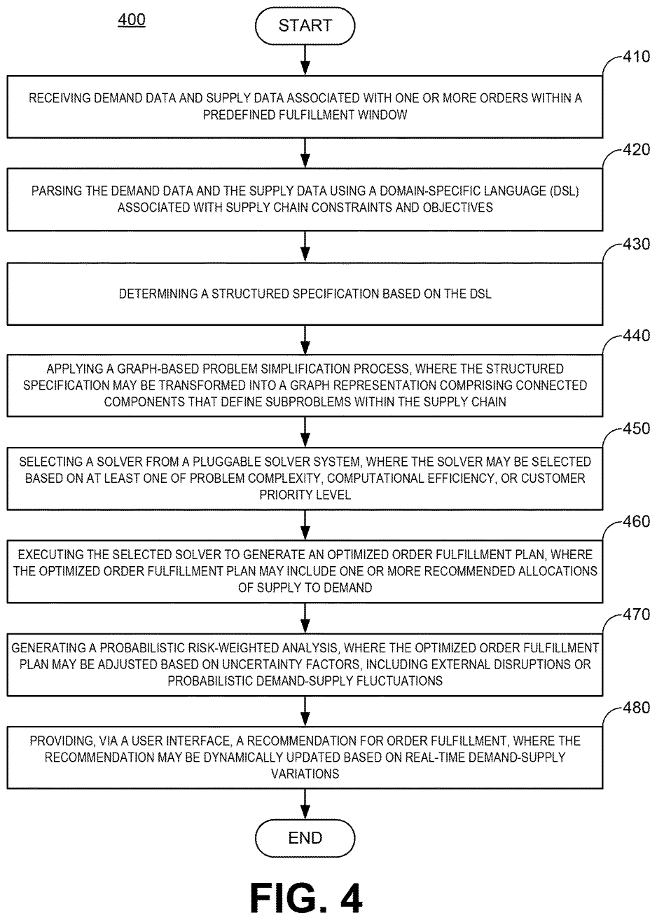

Referring now to FIG. 4, illustrated is a flowchart of a process 400 for IOR in supply chain order fulfillment, according to various embodiments of the present disclosure. The process 400 may provide an automated and adaptive approach for matching demand and supply, considering various business constraints, optimization objectives, and uncertainty factors. The process 400 may be performed by one or more computing devices configured to ingest and process demand and supply data, apply graph-based problem simplification, utilize a pluggable solver system, incorporate probabilistic risk-weighted analysis, and dynamically generate fulfillment recommendations that adapt to real-time supply chain conditions.

At step 410, the process 400 may receive demand data and supply data associated with one or more orders within a predefined fulfillment window. The demand data and supply data may originate from multiple internal and external data sources, including ERP systems, WMS, 3PL providers, transportation management systems (TMS), supplier databases, and real-time inventory tracking platforms. The demand data may include order quantities, requested delivery dates, product specifications, customer priority levels, and/or regional demand distribution. The supply data may include real-time inventory levels, supplier lead times, production constraints, transportation availability, and/or historical fulfillment performance. The data ingestion process may incorporate automated data synchronization mechanisms, allowing the process 400 to track fluctuations in demand and supply in real-time. Moreover, data validation and filtering techniques may be applied to remove inconsistencies or erroneous entries.

At step 420, the process 400 may parse the demand data and supply data using a DSL associated with supply chain constraints and objectives. The DSL processing may enable structured representation of supply chain parameters, as described with respect to the DSL processing module 110 of FIG. 1. The parsing step may include lexical analysis, syntactic parsing, and/or semantic interpretation, converting raw demand and supply data and user-defined rules into structured, machine-readable expressions. For example, if a supply chain manager specifies, “Prioritize shipments from Supplier A if the lead time is less than three days; otherwise, use Supplier B,” the DSL processing may translate this input into an optimization rule that defines priority constraints for solver execution.

In some embodiments, the parsing at step 420 may process DSL expressions that include variable declarations, constraint expressions, conditional expressions, temporal constraint expressions, and/or objective expressions, as described with respect to the DSL processing module 110 of FIG. 1. The lexer may tokenize the input into components such as identifiers, numeric literals, operators, and reserved words. The parser may organize the tokens into an AST based on the production rules of the grammar 166. The interpreter may traverse the AST and generate executable optimization rules that are incorporated into the structured specification.

At step 430, the process 400 may determine a structured specification based on the DSL processing results. The structured specification may include one or more variables representing supply chain parameters, one or more constraints defining allowable order fulfillment conditions, and/or an objective function optimizing a business metric. The objective function may be selected from a set of predefined business goals, including profit maximization, service level improvement, cost minimization, or a weighted combination of these objectives. The structured specification may provide a mathematical representation of the fulfillment problem, as described with respect to the structured specification 112 of FIG. 1.

At step 440, the process 400 may apply a graph-based problem simplification process, where the structured specification is transformed into a graph representation comprising connected components that define subproblems within the supply chain. The transformation into a graph-based model may allow the system to partition large-scale supply-demand allocation problems into smaller, independent subproblems that can be solved separately. Each node in the graph may represent a supply or demand point, while edges may represent fulfillment pathways between supply sources and demand points, as described with respect to the graph-based problem simplification module 116 of FIG. 1.

According to some aspects, the graph-based problem simplification at step 440 may identify connected components using a graph traversal algorithm, such as DFS, BFS, or a union-find data structure. Each connected component may represent an independent subproblem. As described with respect to FIG. 1, the decomposition may reduce the computational complexity from an order of O(2^(m*n)) in the general case to an order of O(m log n), where m represents the number of supply lots and n represents the number of orders, in embodiments where the graph decomposes into multiple connected components. Disconnected nodes (e.g., supply sources with no feasible fulfillment paths to any active demand point) may be excluded from the optimization, further reducing problem size.

At step 450, the process 400 may select a solver from a pluggable solver system, where the solver is chosen based on problem complexity, computational efficiency, or customer priority level. The pluggable solver system may include multiple solver engines, such as Gurobi, CBC, and/or HiGHS, as described with respect to the pluggable solver system 130 of FIG. 1. Each subproblem identified in step 440 may be assigned to an appropriate solver by a problem dispatcher. In some embodiments, the problem dispatcher may evaluate the number of decision variables, the number of constraints, the problem type, and/or historical solve times to select the solver. The pluggable solver system may include a fallback mechanism that automatically switches to an alternative solver if the initially selected solver exceeds a time limit, returns an infeasible result, or fails to meet a quality threshold.

At step 460, the process 400 may execute the selected solver to generate an optimized order fulfillment plan. The optimized fulfillment plan may include one or more recommended allocations of supply to demand. The execution of the solver may account for shipping costs, fulfillment deadlines, supplier reliability, and/or demand fluctuations. The solver-generated solutions may include multiple ranked fulfillment scenarios, allowing decision-makers to compare trade-offs between cost, speed, and risk. In some embodiments, the solver execution process may incorporate sensitivity analysis, evaluating how changes in supply chain parameters (e.g., a supplier capacity reduction or a demand surge) impact the fulfillment recommendations.

At step 470, the process 400 may generate a probabilistic risk-weighted analysis, where the optimized order fulfillment plan is adjusted based on uncertainty factors, including external disruptions or probabilistic demand-supply fluctuations. The probabilistic analysis may evaluate historical supplier performance data, transportation risks, weather disruptions, and/or market conditions to assign risk weights to different fulfillment scenarios, as described with respect to the probabilistic solver module 138 of FIG. 1. For example, if historical trends indicate that a supplier has a 20% probability of shipment delays due to weather, the process 400 may adjust allocations to favor a more reliable supplier. The risk-weighted analysis may generate alternative fulfillment strategies, each representing different trade-offs between cost efficiency, reliability, and service level agreements (SLAs). In some embodiments, the risk-weighted analysis may compute a confidence level for each fulfillment plan, representing the probability that the plan achieves its target performance metrics given estimated uncertainty.

At step 480, the process 400 may provide, via a user interface, a recommendation for order fulfillment, where the recommendation is dynamically updated based on real-time demand-supply variations. The user interface may include a conversational AI assistant that allows supply chain managers to interact with the system via natural language inputs. The recommendations may be displayed through interactive dashboards, ranked allocation scenarios, and/or scenario comparisons. In some embodiments, the user interface may include a geographic map-based visualization displaying supplier and demand locations along with fulfillment pathways. In some embodiments, the user interface may include scenario comparison tools for side-by-side evaluation of alternative fulfillment plans.

The dynamic update mechanism may operate such that as new demand and supply data is ingested, the system automatically recalibrates recommendations in real-time, as described with respect to the real-time monitoring and adaptive recalibration service 224 of FIG. 2. For example, if a supplier reduces available inventory, the process 400 may trigger re-optimization and provide updated recommendations. In some embodiments, the system may allow users to manually override automated recommendations, and such overrides may be logged for audit and analysis.

According to some aspects, the process 400 may further include detecting a demand-supply imbalance and triggering an automated alert. The system may compare aggregated demand against available supply and, upon detecting a shortage or overstock condition, generate and transmit an alert to one or more stakeholders via email, SMS, push notification, or an in-application notification. In some embodiments, the system may classify imbalances by severity and route alerts to different stakeholder groups based on severity level.

According to some aspects, the process 400 may further include generating a demand or supply forecast using a predictive analytics module. The predictive analytics module may use the optimized fulfillment plan, historical fulfillment data from the output database, and/or external signals to forecast future demand-supply mismatches. In some embodiments, the predictive analytics module may use time-series models (e.g., ARIMA or exponential smoothing models) or machine learning models to generate forecasts, as described with respect to FIG. 1.

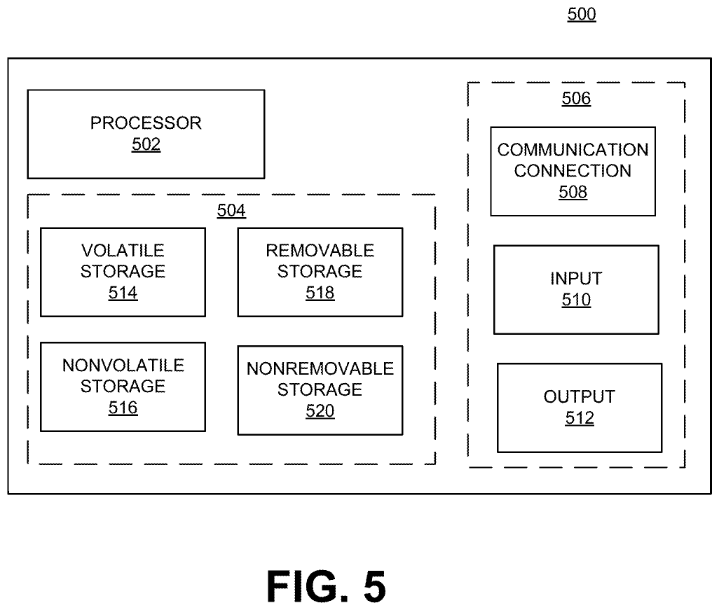

FIG. 5 is a block diagram of a computing device 500 that may be connected to or comprise a component of environment 200. Computing device 500 may comprise hardware or a combination of hardware and software. The functionality to facilitate supply chain order fulfillment and optimization may reside in one or a combination of computing devices 500. Computing device 500 depicted in FIG. 5 may represent or perform functionality of an appropriate computing device 500, or a combination of computing devices 500, such as, for example, a component or various components of a supply chain order fulfillment and optimization system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 5 is exemplary and not intended to imply a limitation to a specific example or configuration. Thus, computing device 500 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 500 may comprise a processor 502 and a memory 504 coupled to processor 502. Memory 504 may contain executable instructions that, when executed by processor 502, cause processor 502 to effectuate operations associated with supply chain order fulfillment and optimization. As evident from the description herein, computing device 500 is not to be construed as software per se.

In addition to processor 502 and memory 504, computing device 500 may include an input/output system 506. Processor 502, memory 504, and input/output system 506 may be coupled together (coupling not shown in FIG. 5) to allow communications between them. Each portion of computing device 500 may comprise circuitry for performing functions associated with each respective portion. Thus, each portion may comprise hardware, or a combination of hardware and software. Accordingly, each portion of computing device 500 is not to be construed as software per se. Input/output system 506 may be capable of receiving or providing information from or to a communications device or other network entities configured for supply chain order fulfillment and optimization. For example, input/output system 506 may include a wireless communication (e.g., 3G/4G/5G/GPS) card. Input/output system 506 may be capable of receiving or sending video information, audio information, control information, image information, data, or any combination thereof. Input/output system 506 may be capable of transferring information with computing device 500. In various configurations, input/output system 506 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 506 may comprise a Wi-Fi finder, a two-way GPS chipset or equivalent, or the like, or a combination thereof.

Input/output system 506 of computing device 500 also may contain a communication connection 508 that allows computing device 500 to communicate with other devices, network entities, or the like. Communication connection 508 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 506 also may include an input device 510 such as keyboard, mouse, pen, voice input device, or touch input device. Input/output system 506 may also include an output device 512, such as a display, speakers, or a printer.

Processor 502 may be capable of performing functions associated with supply chain order fulfillment and optimization, including functions for intelligent order response using automated demand-supply matching, graph-based problem simplification, and probabilistic risk-weighted analysis to optimize order allocation and fulfillment in dynamic supply chain environments, as described herein. For example, processor 502 may be capable of, in conjunction with any other portion of computing device 500, facilitating various functions for the operation of intelligent order response, as described herein.

Memory 504 of computing device 500 may comprise a storage medium having a concrete, tangible, physical structure. As is known, a signal does not have a concrete, tangible, physical structure. Memory 504, as well as any computer-readable storage medium described herein, is not to be construed as a signal. Memory 504, as well as any computer-readable storage medium described herein, is not to be construed as a transient signal. Memory 504, as well as any computer-readable storage medium described herein, is not to be construed as a propagating signal. Memory 504, as well as any computer-readable storage medium described herein, is to be construed as an article of manufacture.

Memory 504 may store any information utilized in conjunction with supply chain order fulfillment and optimization. Depending upon the exact configuration or type of processor, memory 504 may include a volatile storage 514 (such as some types of RAM), a nonvolatile storage 516 (such as ROM, flash memory), or a combination thereof. Memory 504 may include additional storage (e.g., a removable storage 518 or a non-removable storage 520) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 500. Memory 504 may comprise executable instructions that, when executed by processor 502, cause processor 502 to effectuate operations associated with supply chain order fulfillment and optimization.

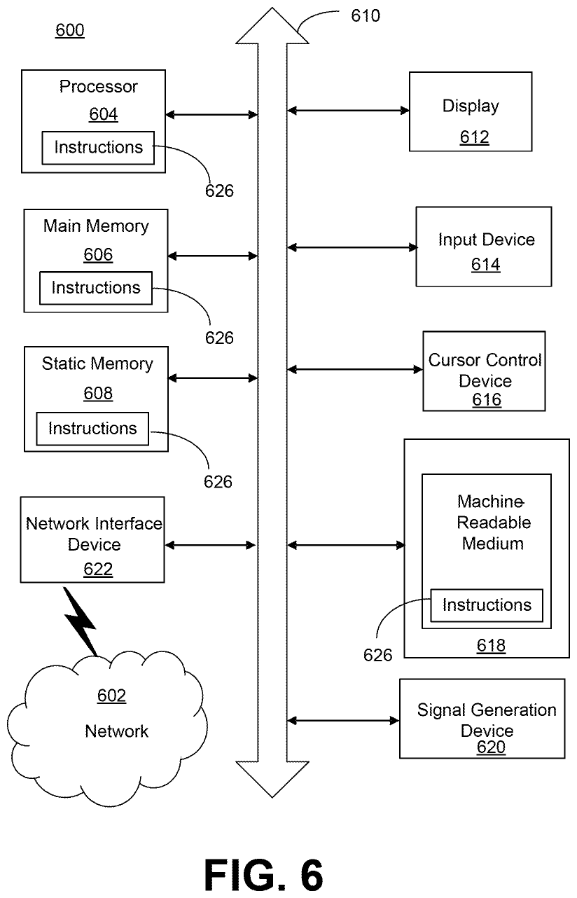

FIG. 6 depicts an exemplary diagrammatic representation of a machine in the form of a computer system 600 within which a set of instructions, when executed, may cause the machine to perform any one or more of the methods described above. One or more instances of the machine can operate, for example, as processor 502, computing environment 210, data store 230, data sources 260, computing devices 270, and other devices of FIGS. 1-5. In some examples, the machine may be connected (e.g., using a network 602) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 600 may include a processor (or controller) 604 (e.g., a central processing unit (CPU)), a graphics processing unit (GPU, or both), a main memory 606 and a static memory 608, which communicate with each other via a bus 610. The computer system 600 may further include a display unit 612 (e.g., a liquid crystal display (LCD), a flat panel, or a solid-state display). Computer system 600 may include an input device 614 (e.g., a keyboard), a cursor control device 616 (e.g., a mouse), a disk drive unit 618, a signal generation device 620 (e.g., a speaker or remote control) and a network interface device 622. In distributed environments, the examples described in the subject disclosure can be adapted to utilize multiple display units 612 controlled by two or more computer systems 600. In this configuration, presentations described by the subject disclosure may in part be shown in a first of display units 612, while the remaining portion is presented in a second of display units 612.

The disk drive unit 618 may include a tangible computer-readable storage medium on which is stored one or more sets of instructions (e.g., instructions 626) embodying any one or more of the methods or functions described herein, including those methods illustrated above. Instructions 626 may also reside, completely or at least partially, within main memory 606, static memory 608, or within processor 604 during execution thereof by the computer system 600. Main memory 606 and processor 604 also may constitute tangible computer-readable storage media.

While examples of a system for supply chain order fulfillment and optimization have been described in connection with various computing devices/processors, the underlying concepts may be applied to any computing device, processor, or system capable of facilitating an IOR system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for supply chain order fulfillment and optimization. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with supply chain order fulfillment and optimization as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing an IOR system as described herein. When implemented on a general-purpose processor, the program code combines with the processor to provide a unique device that operates to invoke the functionality of an IOR system.

While the disclosed systems have been described in connection with the various examples of the various figures, it is to be understood that other similar implementations may be used, or modifications and additions may be made to the described examples of an IOR system without deviating therefrom. For example, one skilled in the art will recognize that an IOR system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure-supply chain order fulfillment and optimization-as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising:
one or more processors configured to:
receive demand data and supply data associated with one or more orders within a predefined fulfillment window;
parse the demand data and the supply data using a domain-specific language (DSL) associated with supply chain constraints and objectives;
determine a structured specification based on the DSL, the structured specification comprising:
one or more variables representing supply chain parameters,
one or more constraints defining allowable order fulfillment conditions, and
an objective function optimizing a business metric including one or more of profit maximization, service level improvement, or cost minimization;
apply a graph-based problem simplification process, wherein the structured specification is transformed into a graph representation comprising connected components that define subproblems within the supply chain;
select a solver from a pluggable solver system, wherein the solver is selected based on at least one of problem complexity, computational efficiency, or customer priority level;
execute the selected solver to generate an optimized order fulfillment plan, the optimized order fulfillment plan comprising one or more recommended allocations of supply to demand;
generate a probabilistic risk-weighted analysis, wherein the optimized order fulfillment plan is adjusted based on uncertainty factors, including external disruptions or probabilistic demand-supply fluctuations; and
provide, via a user interface, a recommendation for order fulfillment, wherein the recommendation is dynamically updated based on real-time demand-supply variations.

2. The one or more computing devices of claim 1, wherein the demand data and supply data are obtained from multiple external and internal data sources, including enterprise resource planning (ERP) systems, warehouse management systems (WMS), and third-party logistics providers.

3. The one or more computing devices of claim 1, wherein the DSL is implemented using a context-free grammar (CFG) defining expressions, variables, operators, constraints, and objectives for supply chain order optimization.

4. The one or more computing devices of claim 1, wherein parsing the demand data and the supply data comprises lexical analysis, syntactic analysis, and semantic interpretation to transform natural language input into a structured machine-readable representation.

5. The one or more computing devices of claim 1, wherein the graph-based problem simplification process partitions the supply chain optimization problem into independent subproblems, each subproblem being solved separately to improve computational efficiency.

6. The one or more computing devices of claim 1, wherein the pluggable solver system comprises at least one of a commercial solver, an open-source solver, or a proprietary solver.

7. The one or more computing devices of claim 6, wherein the selection of the solver is based on a performance metric including one or more of computational speed, accuracy, or cost efficiency.

8. The one or more computing devices of claim 1, wherein the objective function is configurable by a user to prioritize different business goals, including a weighted combination of one or more of profit maximization, service level improvement, or cost minimization.

9. The one or more computing devices of claim 1, wherein the probabilistic risk-weighted analysis is associated with external disruption factors, including one or more of weather events, geopolitical risks, or supplier reliability metrics.

10. The one or more computing devices of claim 9, wherein the probabilistic analysis assigns risk weights to different supply chain scenarios and determines a confidence level associated with each optimized order fulfillment plan.

11. The one or more computing devices of claim 1, wherein the user interface comprises a conversational artificial intelligence (AI) assistant that translates natural language input into structured constraints and objectives for order fulfillment.

12. The one or more computing devices of claim 11, wherein the conversational AI assistant is implemented using a large language model (LLM) trained on historical supply chain data to enhance order optimization recommendations.

13. The one or more computing devices of claim 1, wherein the computing devices are further configured to:
continuously monitor the demand data and the supply data; and
update order fulfillment recommendations based on changes to the demand data or the supply data.

14. The one or more computing devices of claim 1, wherein the graph-based problem simplification reduces computational complexity from an order of (2^(m*n)) to an order of (m log n), wherein m represents the number of supply lots and n represents the number of orders.

15. The one or more computing devices of claim 1, wherein the optimized order fulfillment plan is stored in an output database.

16. The one or more computing devices of claim 1, wherein the order fulfillment recommendations comprise a plurality of ranked allocation scenarios.

17. The one or more computing devices of claim 1, wherein the pluggable solver system comprises a fallback mechanism that switches between solvers in response to computational constraints.

18. The one or more computing devices of claim 1, wherein a demand-supply imbalance detection triggers an automated alert system that notifies stakeholders of shortages or overstock conditions.

19. The one or more computing devices of claim 1, wherein the solver determines an optimal balance between competing objectives by generating a plurality of weighted optimization paths and each of the plurality of weighted optimization paths represents different trade-offs between business priorities.

20. The one or more computing devices of claim 1, wherein output of the solver is integrated into a predictive analytics module and the predictive analytics module forecasts future demand-supply mismatches based on historical trends and real-time data inputs.

21. One or more networked computing devices, comprising one or more processors, configured to:
receive demand data and supply data associated with one or more orders within a predefined fulfillment window;
parse the demand data and the supply data using a domain-specific language (DSL) associated with supply chain constraints and objectives;
determine a structured specification based on the DSL, the structured specification comprising:
one or more variables representing supply chain parameters,
one or more constraints defining allowable order fulfillment conditions, and
an objective function optimizing a business metric including one or more of profit maximization, service level improvement, or cost minimization;
apply a graph-based problem simplification process, wherein the structured specification is transformed into a graph representation comprising connected components that define subproblems within the supply chain;
select a solver from a pluggable solver system, wherein the solver is selected based on at least one of problem complexity, computational efficiency, or customer priority level;
execute the selected solver to generate an optimized order fulfillment plan, the optimized order fulfillment plan comprising one or more recommended allocations of supply to demand;
generate a probabilistic risk-weighted analysis, wherein the optimized order fulfillment plan is adjusted based on uncertainty factors, including external disruptions or probabilistic demand-supply fluctuations; and
provide, via a user interface, a recommendation for order fulfillment, wherein the recommendation is dynamically updated based on real-time demand-supply variations.

22. A method performed by one or more networked computing devices, the method comprising:
receiving demand data and supply data associated with one or more orders within a predefined fulfillment window;
parsing the demand data and the supply data using a domain-specific language (DSL) associated with supply chain constraints and objectives;
determining a structured specification based on the DSL, the structured specification comprising:
one or more variables representing supply chain parameters,
one or more constraints defining allowable order fulfillment conditions, and
an objective function optimizing a business metric including one or more of profit maximization, service level improvement, or cost minimization;
applying a graph-based problem simplification process, wherein the structured specification is transformed into a graph representation comprising connected components that define subproblems within the supply chain;
selecting a solver from a pluggable solver system, wherein the solver is selected based on at least one of problem complexity, computational efficiency, or customer priority level;
executing the selected solver to generate an optimized order fulfillment plan, the optimized order fulfillment plan comprising one or more recommended allocations of supply to demand;
generating a probabilistic risk-weighted analysis, wherein the optimized order fulfillment plan is adjusted based on uncertainty factors, including external disruptions or probabilistic demand-supply fluctuations; and
providing, via a user interface, a recommendation for order fulfillment, wherein the recommendation is dynamically updated based on real-time demand-supply variations.
